(19) United States
(12) Patent Application Publication
(10) Pub. No.: US 2010/0027998 A1
(43) Pub. Date: Feb. 4, 2010

(54) OPTICAL ROUNDABOUT SWITCH

(75) Inventors: Kevin Stuart FARLEY, Ottawa (CA); David W. BOERTJES, Nepean (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: NORTEL NETWORKS LIMITED, St. Laurent (CA)

(21) Appl. No.: 12/183,851

(22) Filed: Jul. 31, 2008

(51) Int. Cl. H04B 10/20; G02B 6/26

(52) U.S. Cl. 398/59; 385/17

(57) ABSTRACT

An optical roundabout comprising optical switching elements arranged in a ring, the routing of the inputs of each internal optical switch to its outputs being ganged, each internal optical switching element having add and drop ports, and connected to its next optical switching element around the ring by an optical waveguide.

### CROSS REFERENCE TO RELATED APPLICATIONS

This application is related to the following applications: U.S. application Ser. No. ______ (Attorney Docket No.: PAT 5375-2) entitled “Ganged Optical Switch” and filed of even date herewith, which is incorporated herein by reference in its entirety.

### FIELD OF THE INVENTION

The present invention relates generally to optical switching junctions.

### BACKGROUND OF THE INVENTION

Optical switching junctions provide branch-point capabilities in optical networks. An optical switching junction may be thought of as a network node with more than 2 input/output pairs. Optical switching junctions can be used to control traffic flow to other network nodes, or they can be locally connected to other optical equipment such as optical add/drop multiplexers to create directionally independent, or multidirectional optical add/drop multiplexing equipment.

Broadcast and select optical switching has been a mainstay of optical network switching technology for many years. Using a broadcast and select optical switching architecture for an N-way junction typically requires the use of N (N−1)×1 splitters and N (N−1)×1 multiplexers. Each of the N (N−1)×1 splitters “broadcasts” incoming signals to the N−1 multiplexers. Any one of the N−1 multiplexers can then “select” the “broadcast” signal and retransmit it.

The broadcast and select arrangement broadcasts all incoming traffic, which is advantageous in situations where multicasting is desired. However, broadcast and select switching's inherent multicasting necessarily comes at the cost of splitting the power of every incoming signal by a factor of (N−1). Because the power level of the incoming signal is split in this way, it becomes difficult to scale up a broadcast and select switching architecture to construct N-way junctions for large values of N. Further, this power splitting effect is not insignificant even in a junction with a low value of N, such as a 3-way junction. Accordingly, where multicasting is not required, a switch architecture that does not exhibit the power-splitting of a broadcast and select switching architecture is desired.

Because broadcast and select junctions necessarily involve the interconnection of each input and each output, a large number of components is required. For example, a 3-way broadcast and select junction requires at least three 2×1 splitter demultiplexers, and at least three 2×1 multiplexers. A 4-way broadcast and select junction requires at least four 3×1 splitter demultiplexers, and at least four 3×1 multiplexers. Further, broadcast and select junctions require more fibering, which adds complexity and takes up physical space in the junction component itself. Accordingly, where multicasting is not required, a switch architecture that does not involve such a large number of complex components would be both simpler and more economical.

A 3-way broadcast and select arrangement can be used to create a directionally independent optical add/drop multiplexer (DIOADM) with branching capability, as shown in FIG. 10A. A DIOADM with branching capability can be created by multiplexing a series of transmitters and feeding this multiplexed output into one branch of a 3-way broadcast and select junction and by demultiplexing the output of that same branch of the junction into a series of receivers. This arrangement can be extended in the case of a 4-way broadcast and select junction to create a DIOADM with even greater branching capability. It can also be extended in the case of a 4-way broadcast and select junction to create a bidirectional optical add/drop multiplexer (OADM). Applications of bidirectional optical add/drop multiplexers include protection arrangements where two OADMs are coupled by a 4-way junction to create a bidirectional OADM, where one of the OADM's is a reserve in case the other fails. In both the case of DIOADMs and bidirectional OADMs constructed using broadcast and select switches, the inherent multicasting and corresponding power splitting of the broadcast and select junctions results in undesirable, but unavoidable, losses. Accordingly, where multicasting is not required, a switch architecture that does not exhibit the power-splitting of a broadcast and select switching architecture would enable the construction of DIOADMs with branching capabilities, or bidirectional OADMs, that are not subject to power-losses due to signal splitting.

It is, therefore, desirable to provide a device that has the ability to perform the same functions as a broadcast and select junction, without the disadvantage of power-splitting. It is also desirable to provide a device that provides the functionality of a broadcast and select junction, without using as many components and fibering.

### SUMMARY OF THE INVENTION

It is an object of the present invention to obviate or mitigate at least one disadvantage of previous broadcast and select optical junctions.

In a first aspect, the present invention provides a 3-way optical roundabout comprising three internal optical switching elements arranged in a ring. Each optical switching element has two input ports routable to two output ports. The routing of the first input of each internal optical switch is ganged to the routing of the second input for that switch. Each internal optical switching element's two input ports include an add port and a roundabout-in port, and each internal optical switching element's two output ports include a drop port and a roundabout-out port. The roundabout-out port of each optical switching element is connected to the roundabout-in port of its next optical switching element around the ring by an optical waveguide.

In some embodiments, a 3-way optical roundabout also includes three external connections arranged in a ring. These external connection can have a drop output port in optical communication with the drop output port of a corresponding internal optical switching element and an add input port in optical communication with the add input port of the next optical switching element around the ring from said corresponding internal optical switching element. Several switch states are possible in these embodiments. In one embodiment, each internal optical switching element has a single-hop unidirectional switching state for routing optical signals from the add port of each external connection to the drop port of its next external connection around the ring. In another embodiment, each internal optical switching element has a double-hop unidirectional switching state for routing optical signals from its add port to the drop port of the previous internal optical switching element around the ring. In still another embodiment, the optical roundabout has three rotationally symmetric bidirectional switching states for routing optical signals between two external connections when any two of the internal optical switching elements are in a first switching state and the remaining internal optical switching element is in a second switching state.

In other embodiments, a 3-way optical roundabout can include three external connections arranged in a ring, with each external connection having a drop output port in optical communication with the drop output port of a corresponding internal optical switching element and an add input port in optical communication with the add input port of the same corresponding internal optical switching element. Possible switch states in these embodiments include one where each internal optical switching element has a single-hop unidirectional switching state for routing optical signals from the add port of each external connection to the drop port of its next external connection around the ring. In another embodiment, the optical roundabout has at least one bidirectional switching state for routing optical signals between two external connections in which two of the internal optical switching elements are in a first switching state and the remaining internal optical switching element is in a second switching state.

In some embodiments of 3-way optical roundabouts, variable optical attenuators can be connected to a port of one of the internal optical switching elements. Other embodiments of 3-way optical roundabouts can have a multiplexer with an output port in optical communication with the add port of one of the three internal optical switching elements, or a demultiplexer with an input port in optical communication with the drop port of one of the three internal optical switching elements.

In a second aspect, the present invention provides a 3-way optical roundabout switch comprising three internal optical switching elements each having a first input, a first output, a second input for adding optical signals, and a second output for dropping optical signals. Optical waveguides connect the first output of the first optical switch to the first input of the second optical switch, the first output of the second optical switch to the first input of the third optical switch, and the first output of the third optical switch to the first input of the first optical switch. The routing of the first input within each of the three optical switching elements is ganged to the routing of the second input for that switch.

In an embodiment of a 3-way optical roundabout, the optical switching elements are parallel-bar switches. In another embodiment of a 3-way optical roundabout, the optical switching elements are crossbar switches. In another embodiment, the second input of the optical roundabout's first switch is connected to the output of a multiplexer, and the second output of the first switch is connected to the input of a demultiplexer.

In a third aspect, the present invention provides an M-way optical roundabout switch comprising M optical (M−1)×(M−1) optical cross-connects, where M is at least three. Each of the M optical cross-connects has an (M−1)th input for adding an optical signal, and an (M−1)th output for dropping an optical signal. There are M−2 optical waveguides connecting the first M−2 outputs of the Nth optical cross-connect to the first M−2 inputs of the (N+1)th optical cross connect, for 1≦N≦M. There are also M−2 optical waveguides connecting the first M−2 outputs of the Mth optical cross-connect to the first M−2 inputs of the first optical cross connect.

In a fourth aspect, the present invention provides an optical switch module for an optical roundabout switch, including a first internal optical switching element and a second optical switching element, each of said first and second optical switching elements having first and second inputs, and first and second outputs. The module also includes a selective dropping means for selectably dropping an optical signal from the first output of either of the first optical switch or the second optical switch, and a selective adding means for selectably adding an optical signal to the second input of either the first optical switch or the second optical switch. The routing of the first input within each of the optical switching elements is ganged to the routing of the second input for that optical switching element.

In an embodiment, the present invention provides a 4-way optical roundabout switch including four optical switch modules as described above, arranged in a ring. An optical waveguide connects the second output of the first optical switching element of each optical switch module to the first input of the first optical switching element of a next optical switch module around the ring, and an optical waveguide connects the second output of the second optical switching element of each optical switch module to the first input of the second optical switching element of the next optical switch module around the ring. In another embodiment, the selective adding means of the first optical switching module is connected to the output of a multiplexer, and the selective dropping means of the first optical switching module is connected to the input of a demultiplexer. In a yet another embodiment, the selective adding means of the first optical switching module is connected to the output of a multiplexer, the selective dropping means of the first optical switching module is connected to the input of a demultiplexer, the selective adding means of the third optical switching module is connected to the output of a multiplexer, and the selective dropping means of the third optical switching module is connected to the input of a demultiplexer.

In a fifth aspect, the present invention provides an optical roundabout switch made up of four optical switch modules arranged in a ring, an optical waveguide connecting the second output of the first optical switching element of each optical switch module to the first input of the first optical switching element of a next optical switch module around the ring; and an optical waveguide connecting the second output of the second optical switching element of each optical switch module to the first input of the second optical switching element of the next optical switch module around the ring. Each optical switch module includes a first internal optical switching element and a second optical switching element, and each of the first and second optical switching elements has first and second inputs, and first and second outputs. Each optical switch module also includes a selective dropping means for selectably dropping an optical signal from the first output of either of the first optical switch or the second optical switch, and a selective adding means for selectably adding an optical signal to the second input of either the first optical switch or the second optical switch. The routing of the first input within each of the optical switching elements is ganged to the routing of the second input for that optical switching element.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A is a conceptual illustration of a 3-way optical roundabout switch constructed of parallel-bar type switches in a configuration providing unidirectional connectivity between each port and its adjacent counterclockwise port, according to an embodiment of the present invention;

FIG. 1B is a conceptual illustration of a 3-way optical roundabout switch constructed of parallel-bar type switches in a configuration providing unidirectional connectivity between each port and its adjacent clockwise port, according to an embodiment of the present invention;

FIG. 1C is a conceptual illustration of a 3-way optical roundabout switch constructed of parallel-bar type switches in a configuration providing bidirectional connectivity between two ports, according to an embodiment of the present invention;

FIG. 2A is a conceptual illustration of a 3-way optical roundabout switch constructed of crossbar type switches in a configuration providing unidirectional connectivity between each port and its adjacent counterclockwise port, according to an embodiment of the present invention;

FIG. 2B is a conceptual illustration of a 3-way optical roundabout switch constructed of crossbar type switches in a configuration providing unidirectional connectivity between each port and its adjacent clockwise port, according to an embodiment of the present invention;

FIG. 2C is a conceptual illustration of a 3-way optical roundabout switch constructed of crossbar type switches in a configuration providing bidirectional connectivity between two ports, according to an embodiment of the present invention;

FIG. 3 is a conceptual illustration of a 3-way optical roundabout switch in an alternate parallel-bar configuration having bidirectional capability, according to an embodiment of the present invention;

FIG. 4A is a conceptual illustration of the unidirectional switch state for a 3-way optical roundabout switch comprising switches that bias the roundabout in favour of an anticlockwise unidirectional switching state, according to an embodiment of the present invention;

FIG. 4B is a conceptual illustration of a possible bidirectional switch state for a 3-way optical roundabout switch comprising switches that bias the roundabout in favour of an anticlockwise switching state, according to an embodiment of the present invention;

FIG. 5A is a conceptual illustration of an exemplary parallel-bar type switch implemented using a tilting MEMS mirror element, corresponding to the “/” state of the switches illustrated conceptually in FIGS. 1A-C;

FIG. 5B is a conceptual illustration of the exemplary parallel-bar type switch of FIG. 5A, corresponding to the “=” state of the switches illustrated conceptually in FIGS. 1A-C;

FIG. 6 is a conceptual illustration of a switching element that can be used to construct a 4-way optical roundabout switch according to an embodiment of the present invention;

FIG. 7 is a conceptual illustration of a 4-way optical roundabout switch according to an embodiment of the present invention;

FIG. 8 is a conceptual illustration of a 4-way optical roundabout switch in a configuration providing bidirectional connectivity between a first optical switch module and a second optical switch module, and providing bidirectional connectivity between a third optical switch module and a fourth optical switch module, according to an embodiment of the present invention;

FIG. 9 is a conceptual illustration of a 4-way optical roundabout switch in a configuration providing bidirectional connectivity between a first optical switch module and a third optical switch module, and providing bidirectional connectivity between a second optical switch module and a fourth optical switch module, according to an embodiment of the present invention;

FIG. 10A is an illustration of a prior art DIOADM branching capability implemented using a broadcast and select switching architecture, according to an embodiment of the present invention;

FIG. 10B is an illustration of a DIOADM branching capability implemented using a 4-way roundabout optical switching architecture, according to an embodiment of the present invention; and

FIG. 11 is a conceptual illustration of an N-way optical roundabout switch, according to an embodiment of the present invention.

### DETAILED DESCRIPTION

Generally, the following describes novel optical switching architectures that can be used to construct junctions, which can be used as stand-alone optical junctions or to construct branching DIOADMs, or branching bidirectional OADMs. As an aid for understanding the construction of these novel optical switching architectures, we will refer to a loose analogy that can be drawn between optical traffic patterns and automotive traffic patterns, and specifically the patterns automotive traffic follow in a roundabout, which is a common European traffic-management method. The analogy is not perfect, however, since automobiles are discrete entities, whereas the flow of traffic in the presently disclosed optical switch can consist of a continuous stream of information. The analogy is also imperfect because it is not necessary that some on-ramps to the presently disclosed optical switch be set to a blocking state for all wavelengths in order to allow other traffic to pass, as would be the case in an automotive roundabout; accordingly, although the examples disclosed in the following description relate to single-wavelength switching (or switching all wavelengths at once), it will be appreciated that the embodiments of the present invention described herein may be implemented using wavelength-selective switch elements.

Because we discuss circular traffic patterns, the terms clockwise, anticlockwise and counter-clockwise appear frequently. The term ring, as used herein, is used to described any arrangement of elements whose optical communication pattern is topologically equivalent to a ring, circle, or other simply connected although various geometries may be used in practice. It should be understood by the reader that the terms anticlockwise and counter-clockwise are synonymous, and that both indicate a circular direction of travel that is opposite to a clockwise direction of travel. As used herein, the terms “around the ring” can mean either clockwise or counterclockwise travel around the ring, such that if reference is made, for example, to a next optical switching element around the ring

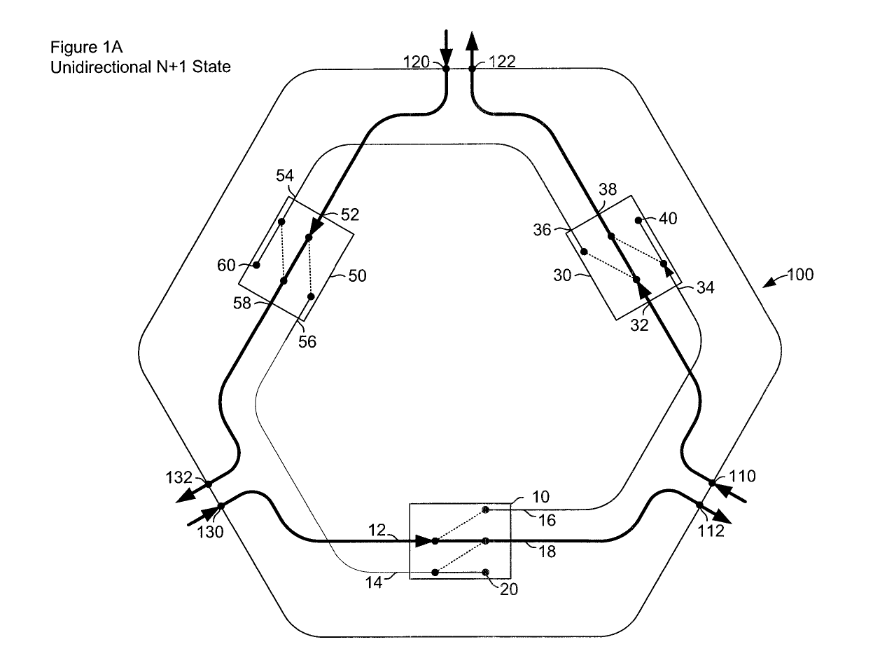

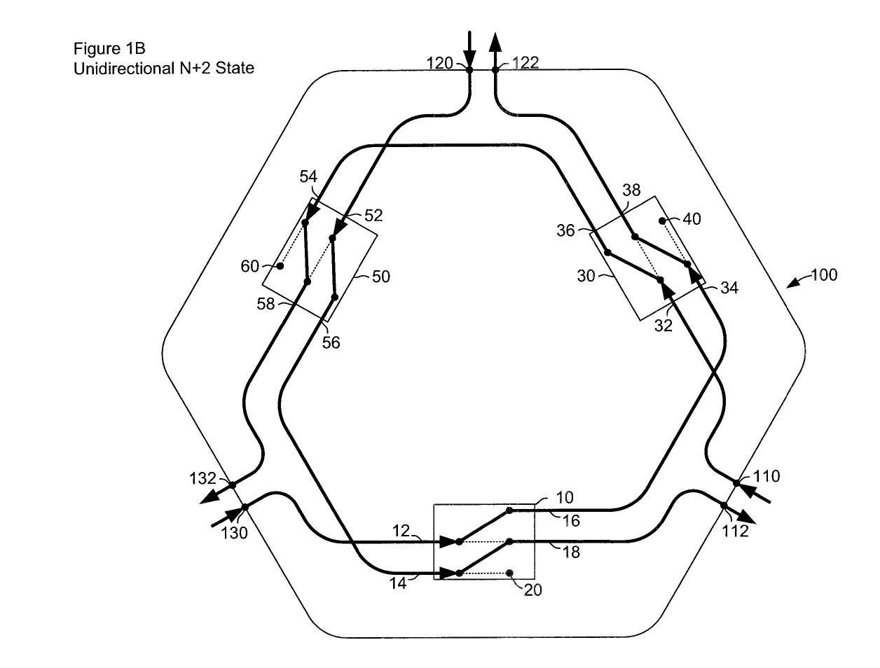

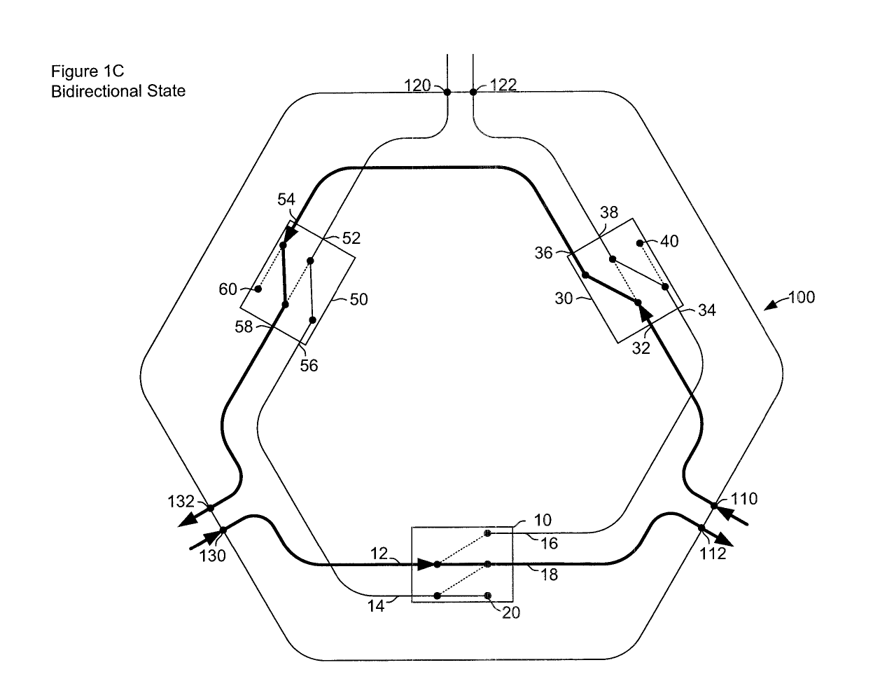

The simplest optical roundabout switch is a 3-way junction, as exemplified conceptually in FIGS. 1A-4B. The operation and construction of a 3-way junction implemented using an optical roundabout switch architecture will now be described with reference to these Figures.

Having regard to FIGS. 1A-C, a 3-way junction implemented using an optical roundabout switch architecture comprises three switches, numbered 10, 30 and 50 respectively. Switch 10 has first and second input ports 12 and 14, and first and second output ports 16 and 18. Switch 10's port 12 is an add port, which, in making use of the “roundabout” analogy, we can call an “on-ramp”. Switch 10's port 18 is a drop port, which, in making use of the “roundabout” analogy, we can call an “off-ramp”. Switch 10's port 14 receives input from another switch in the overall 3-way junction, which, in making use of the “roundabout” analogy, we can call a “roundabout in” port, for convenience. Switch 10's port 16 sends output to another switch in the overall 3-way junction, which, in making use of the “roundabout” analogy, we can call a “roundabout out” port, for convenience. Switch 10 has a DUMP position 20, which conceptually illustrates a “don't care” configuration wherein data transmitted by the switch to the DUMP position 20 is lost for the purposes of a typical add/drop implementation, although it will be appreciated that use could be made of information that is sent to the DUMP position beyond the purposes of the embodiments disclosed herein. Switches 30 and 50 have add ports 32 and 52; roundabout in ports 34 and 54; roundabout out ports 36 and 56; drop ports 38 and 58; and dump positions 40 and 60, respectively.

In the particular configuration shown in FIGS. 1A-C, each switch is a parallel-bar type switch, configured so that the routing of the first input within each of the three optical switches is tied to the routing of the second input for that switch. In the particular embodiment illustrated conceptually in FIGS. 1A-C, the routing of the first input is such that when the switch is in a first position, which can be referred to for the sake of convenience as the “/” position, the add port is connected to the roundabout out port, and the roundabout in port is connected to the drop port. This configuration of a parallel bar switch allows an alternate switch position, which can be referred to for the sake of convenience as the “=” position, where the tied routing of both inputs causes the add port to connect to the drop port, while the roundabout in port will connect to the DUMP position. For the sake of convenience, this tied routing of inputs in the switches of the present invention can be referred to as “ganging” and the switch can be described as a “ganged” switch, or a “ganged optical switch”. Ganged optical switches generally, and various useful applications thereof, are generally described in U.S. application Ser. No. ______ (Attorney Docket No.: PAT 5375-2) entitled “Ganged Optical Switch”, filed of even date herewith, which is incorporated herein by reference in its entirety.

Each switch in the 3-way optical roundabout switch is connected to each of the two other switches such that the roundabout out port of each switch is connected to the roundabout in port of the next successive switch. For example, in FIGS. 1A-C the output 16 of switch 10 is connected to the input 34 of switch 30, the output 36 of switch 30 is connected to the input 54 of switch 50, and the output 56 of switch 30 is connected to the input 14 of switch 10. It will be appreciated by the skilled reader that the entire arrangement illustrated in FIGS. 1A-C is biased in favour of anticlockwise data transmission around the roundabout, but this is not necessary and the arrangement can easily be biased in favour of clockwise data transmission if “mirrored”. Those of skill in the art will appreciate that the particular switches used to implement this roundabout arrangement can be selected from among the many optical switches capable of assuming the routing states illustrated. Examples of such switches include: a micro electromechanical system (MEMs) comprising a tilting mirror switching element; a MEMs comprising a diffraction steering switching element, a Mach-Zehnder switching element, and a polarization rotation switching element. Planar lightguide circuits could also be used to implement the present invention; for example: a polarization rotation switching element that could be used in an embodiment of the present invention as an optical switching element could be implemented using a combination of waveguides and free space optics.

As noted in the preceding paragraph, one exemplary switching element that can be used in accordance with the present invention is a MEMs tilting mirror switching element. An exemplary MEMs tilting mirror switching element is illustrated in FIGS. 5A and 5B, corresponding to the “/” and “=” positions of the switches illustrated in FIGS. 1A-C, respectively. The switching elements of FIGS. 5A and 5B have the following inputs and outputs: each switching element has an input labelled “Add”; an input labelled “Roundabout In”, an output labelled “Drop”; and an output labelled “Roundabout Out”. A signal 400 entering the switching element of FIG. 5A via the Add input is directed towards a tilting mirror or diffractive switching element 490 constructed using suitable MEMs technology, and the signal is then reflected by the mirror, which is in the “/” position 490, exiting the switching element via the Roundabout Out output. A signal 410 entering the switching element of FIG. 5A via the Roundabout In input is directed towards the same tilting mirror switching element in the “/” position 490 as the signal 400 was, thereby ensuring that both inputs are tied, or ganged. The signal 410 is reflected by the mirror and redirected towards the Drop output. Turning to FIG. 5B, where the mirror element is in the “=” position 495, it can be seen at a signal 400 entering the switching element via the Add input is directed towards the mirror 495, and reflected by the mirror 495 towards the Drop output. Similarly, since the inputs are tied, or ganged, according to the position of mirror 495, a signal 410 entering the switching element via the Roundabout In input is reflected by the mirror 495 towards the Dump, or “don't care” position. As previously indicated, any optical switch that is capable of displaying a set of switching states where both inputs are tied, or ganged, can be substituted for the switch elements of FIGS. 5A and 5B, including without limitation semiconductor-optical switches, liquid crystal based switches, Mach-Zehnder based switches, MEMs based switches, and polarization-rotation switches.

Given these possible tied switch states, an optical roundabout such as the exemplary optical roundabout of FIGS. 1A-C can be constructed having 8 roundabout states. Two roundabout states provide unidirectional routing for all three of the roundabout's ports, either sending each port's input one hop (N+1) anticlockwise about the roundabout, as illustrated in FIG. 1A, or sending each port's input two hops (N+2) anticlockwise about the roundabout. Of course, the N+1 anticlockwise routing state is equivalent to an N+2 clockwise routing state, and an N+2 anticlockwise routing state is equivalent to an N+1 clockwise routing state. Both the N+1 and N+2 routing states are rotationally symmetric. Three roundabout states are bidirectional routing states between any two roundabout ports, as illustrated in FIG. 1C; these states are rotationally symmetric, and so only one is illustrated. Finally, three unidirectional roundabout states exist where two single anticlockwise hops from port N to N+1, and port N+1 to N+2 occur, which is equivalent to the unidirectional roundabout state of FIG. 1A, where one of the port-to-port connections is broken by a “/” switch state.

FIG. 1A illustrates a unidirectional roundabout state where each port's input is transmitted one anticlockwise hop around the roundabout. The positions of the three switches in FIG. 1A, each of which is in the “=” configuration, permit signals to be transmitted along the optical roundabout simultaneously in a unidirectional fashion, dropping signals added at any given port at the next port anticlockwise around the roundabout. A signal entering the junction at external connection 110 is transmitted via input 32 and switch 30 to output 38 to external connection 122, which is the next port anticlockwise around the roundabout (i.e. N+1). Similarly, signals entering the junction at external connection 120 are transmitted to external connection 132, and signals entering the junction at external connection 130 are transmitted to external connection 112. This optical roundabout state can be referred to, for convenience, as a “=, =, =” state, since each switch is in a “=” configuration, as illustrated in FIG. 5B.

In placing the overall optical roundabout within the context of a larger system external to the components illustrated in FIGS. 1A-C, ports 110 and 112 can be conveniently described as forming a first external connection of the optical roundabout of FIGS. 1A-C. Accordingly external connection 110 can also be thought of as the first external connection's add port, and external connection 112 can also be thought of as the first external connection's drop port. This first external connection can, for example, be connected in a bidirectional fashion to additional optical equipment located some distance away from the optical roundabout in a first direction. Similar labels can be applied to ports 120 and 122, which can be conveniently described together as a second external connection, and individually as the second external connection's add external connection 120 and drop external connection 122. By the same token, ports 130 and 132 can be conveniently described as a third external connection, and individually as the third external connection's add external connection 130 and drop external connection 132. The second external connection might, for example, communicate with a piece of optical equipment in a second direction, and the third external connection might, for example, communicate with some other piece of optical equipment in a third direction.

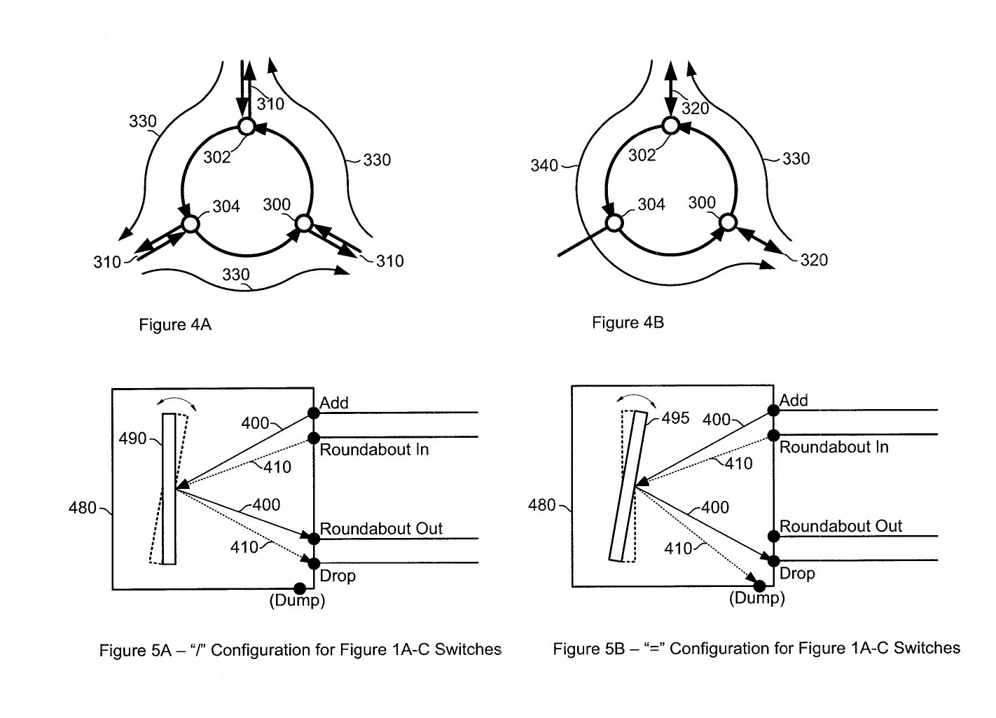

The configuration of FIG. 1A can be illustrated conceptually as shown in FIG. 4A. FIG. 4A includes three external connections, numbered 300, 302 and 304. Each external connection can both add and drop signals, and includes illustrated in FIG. 4A as separate pairs of arrows 310 to emphasize the contrast between FIGS. 4A and 4B: whereas the connectivity of the roundabout switch in FIG. 4B is effectively bidirectional, as will be described below with reference to FIG. 1C, the connectivity in the roundabout switch of FIG. 4A is unidirectional. Accordingly, signals added to the roundabout at port 300 are dropped at port 302, signals added to the roundabout at port 302 are dropped at port 304, and signals added to the roundabout at port 304 are dropped at port 300. As illustrated, the flow around the roundabout of FIG. 4A is anticlockwise, and the switch states are configured such that inputs flow in single anticlockwise hops 330 around the roundabout. Although this state exhibits rotational symmetry in the mathematical sense, the three possible rotational states are all equivalent, and must be considered a single state for functional purposes, so long as the individual switch elements 300, 302, and 304, and the fibre that connects them, are functionally equivalent.

FIG. 1B illustrates a unidirectional roundabout state where each port's input is transmitted two anticlockwise hops around the roundabout. The positions of the three switches in FIG. 1B, each of which is in the “/” configuration, permit signals to be transmitted along the optical roundabout simultaneously in a unidirectional fashion, dropping signals added at any given port at the port after the next port anticlockwise around the roundabout (effectively, the next port clockwise about the roundabout). A signal entering the junction at external connection 110 of FIG. 1B is transmitted via input 32 and switch 30 to output 36, where it is transmitted via input 54 and switch 50 to output 58 and external connection 132, which is the port after the next port anticlockwise around the roundabout (i.e. N+2). Similarly, signals entering the junction of FIG. 1B at external connection 120 are transmitted to external connection 112, and signals entering the junction at external connection 130 are transmitted to external connection 122. This optical roundabout state can be referred to, for convenience, as a “/, /, /” state, since each switch is in a “/” configuration, as illustrated in FIG. 5A.

FIG. 1C illustrates a bidirectional roundabout state where a first port's input is transmitted two anticlockwise hops around the roundabout to a second port, and the second port's input is transmitted one anticlockwise hop around the roundabout to the first port, thus establishing bidirectional communication between the first and second ports. The positions of the three switches in FIG. 1C, are not all the same: switch 10 is in the “=” state, while switches 30 and 50 are in the “/” state. Accordingly, a signal entering the junction at external connection 110 of FIG. 1C is transmitted via input 32 and switch 30 to output 36, where it is transmitted via input 54 and switch 50 to output 58 and external connection 132, which is the port after the next port anticlockwise around the roundabout (i.e. N+2). However, unlike the case illustrated in FIGS. 1A and 1B, signals entering the junction of FIG. 1B at external connection 120 are transmitted to dump port 20, where they may be used for purposes other than those of the present invention. Signals entering the junction at external connection 130 are transmitted to external connection 112 via switch 10. This optical roundabout state can be referred to, for convenience, as a “=, /, /” state, since switch 10 is in a “=” configuration while switches 30 and 50 are in a “/” configuration. Of course, it should be appreciated that corresponding bidirectional states “/, =, /” and “/, /, =” exist, which are rotationally symmetric to the configuration illustrated in FIG. 1C.

Having regard to the foregoing description and the exemplary optical roundabout illustrated in FIGS. 1A-C, it can be seen that the 3-way optical roundabout uses half as many components as a 3-way broadcast and select junction, and that the absence of splitters means that losses are correspondingly lower than they would be in a 3-way broadcast and select junction, which reduces the signal strength of each incoming signal by at least a factor of two.

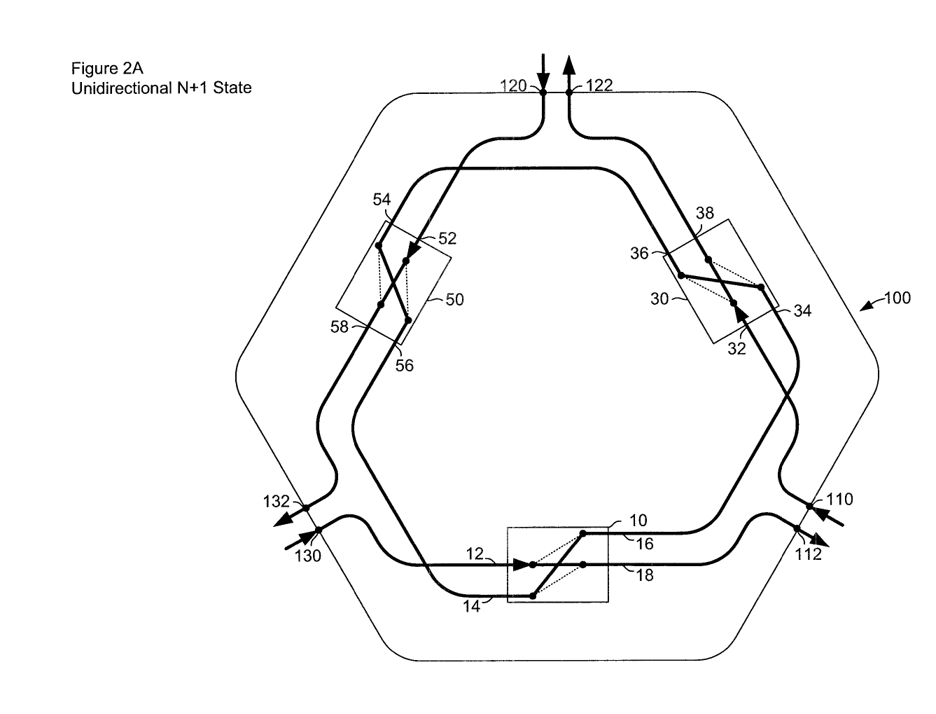

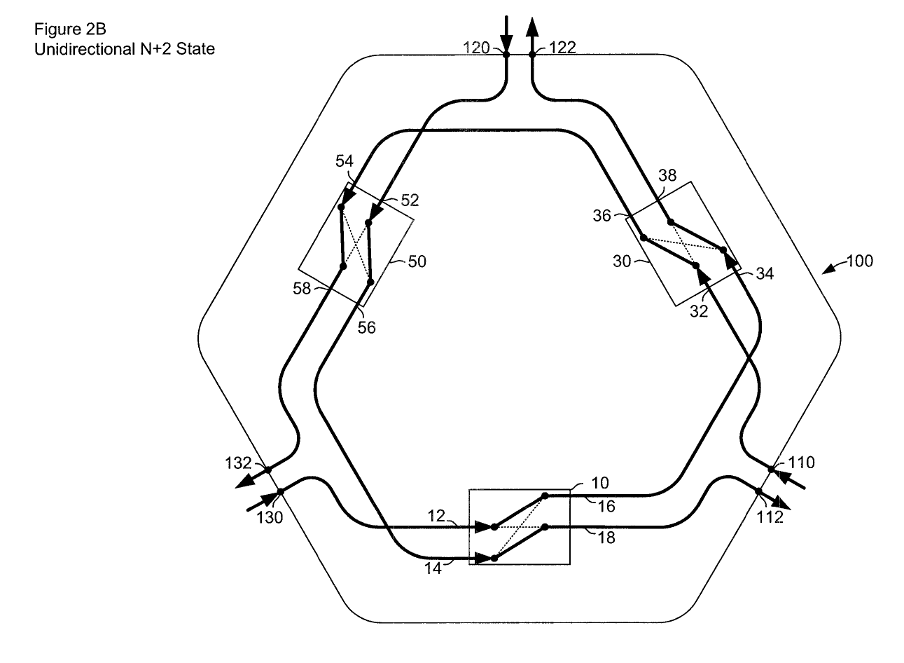

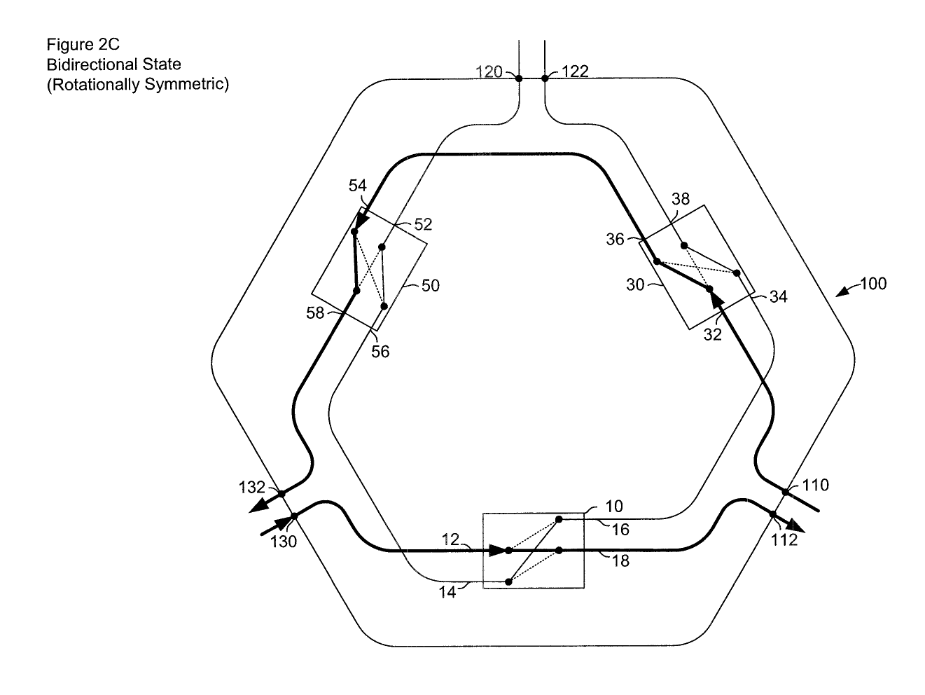

In each bidirectional routing state of the 3-way roundabout illustrated in FIG. 1C (and also the 3-way roundabout illustrated in FIG. 2C, described below), it should be appreciated that, since the two paths of the bidirectional traffic flow propagate over separate optical switching elements, each path can be independently controlled. This independent control can include the setting up of each connection, and the modification of each connection. An exemplary advantage inherent in this arrangement is that attenuation control components could be incorporated into the switch in order to enable the optimisation of switch attenuation to optimize the loss of the two paths.

The configuration of FIG. 1C can be illustrated conceptually as shown in FIG. 4B. FIG. 4B includes three ports, numbered 300, 302 and 304. Each port has both add and drop ports, the traffic flows of which are illustrated in FIG. 4B as single lines 320 because they are bidirectional. As illustrated, the flow around the roundabout of FIG. 4B is anticlockwise, and the switch states are configured such that signals added to port 300 are transmitted along path 330 and dropped at port 302, while inputs added at port 302 are transmitted along path 340 and dropped at port 300, bypassing port 304. This effectively creates a bidirectional optical connection between the add/drop ports for ports 300 and 302.

Having regard to the foregoing description and the illustrations in FIGS. 1A-C, the following state table can be constructed, representing the eight possible states of the optical roundabout switch of FIGS. 1A-C:

| | External | External | External |
|---|---|---|---|
| | Connection 110 | Connection 120 | Connection 130 |
| Switch State | Routed to: | Routed to: | Routed to: |
| /, /, / | 132 | 112 | 122 |
| /, /, = | 60 | 132 | 122 |
| /, =, / | 122 | 112 | 40 |
| /, =, = | 122 | 132 | 40 |
| =, /, / | 132 | 20 | 112 |
| =, /, = | 60 | 132 | 112 |
| =, =, / | 122 | 20 | 112 |
| =, =, = | 122 | 132 | 112 |

30

Parallel-bar type switches are not the only possible means of constructing a 3-way optical roundabout switch. It should also be appreciated that a 3-way optical roundabout switch can be constructed using cross-bar switches, as illustrated conceptually in FIGS. 2A-C. Each of the switches of FIGS. 2A-C may assume either a “=” position or a “x” position, according to the state that is desired for the optical roundabout switch. In contrast to the optical roundabout switch illustrated in FIGS. 1A-C, the “=” position in cross-bar type switch 10 of FIG. 2A connects the input 12 of switch 10 to output 16 of that switch, whereas the “x” switch state connects the input 12 to output 18. Because the routing of both inputs is tied, or ganged, each input in a cross-bar switch must always be routed to the output that the other input is not routed to, and there is no need for a drop, or “don't’ care” position as is the case in the parallel-bar switches used to construct the roundabouts illustrated in FIGS. 1A-1C. It should be appreciated that the input-output routing of the cross-bar switch may be inverted, with corresponding changes to the potential states of the overall switch, and that the overall switch can be mirrored in order to operate in an anticlockwise configuration, just as with the case for the parallel-bar type switch. The switches that make up the overall 3-way cross-bar type optical roundabout switch may be any type of optical switch that is capable of cross-bar type behaviour, for example: optical switching elements that employ polarisation switching techniques may be used as switch elements 10, 30 and/or 50. Similarly to the parallel-bar type switch, the optical roundabout illustrated in FIG. 2 can assume eight different states depending on the individual switch positions. The unidirectional N+1 case is illustrated in FIG. 2A, the unidirectional N+2 case is illustrated in FIG. 2B, and the bidirectional case is illustrated in FIG. 2C (for any configuration having two switches in a “=” state and one switch in a “x” state). Unlike the arrangement of FIGS. 1A-1C, however, a unidirectional state exists, which can be achieved in four possible ways, where two switches are in a “x” configuration and one switch is in a “=” configuration. The following state table illustrates:

| | External | External | External |
|---|---|---|---|
| | Connection 110 | Connection 120 | Connection 130 |
| Switch State | Routed to: | Routed to: | Routed to: |
| x, x, x | 122 | 132 | 112 |
| x, x, = | 122 | 132 | 112 |
| x, =, x | 122 | 132 | 112 |
| x, =, = | 132 | 122 (loopback) | 112 |
| =, x, x | 122 | 132 | 112 |
| =, x, = | 122 | 112 | 132 (loopback) |
| =, =, x | 112 (loopback) | 132 | 122 |
| =, =, = | 132 | 112 | 122 |

In placing the overall optical roundabout within the context of a larger system external to the components illustrated in FIGS. 2A-C, ports 110 and 112 can be conveniently described as forming a first external connection of the optical roundabout of FIGS. 2A-C. Accordingly external connection 110 can also be thought of as the first external connection's add port, and external connection 112 can also be thought of as the first external connection's drop port. This first external connection can, for example, be connected in a bidirectional fashion to additional optical equipment located some distance away from the optical roundabout in a first direction. Similar labels can be applied to ports 120 and 122, which can be conveniently described together as a second external connection, and individually as the second external connection's add external connection 120 and drop external connection 122. By the same token, ports 130 and 132 can be conveniently described as a third external connection, and individually as the third external connection's add external connection 130 and drop external connection 132. The second external connection might, for example, communicate with a piece of optical equipment in a second direction, and the third external connection might, for example, communicate with some other piece of optical equipment in a third direction.

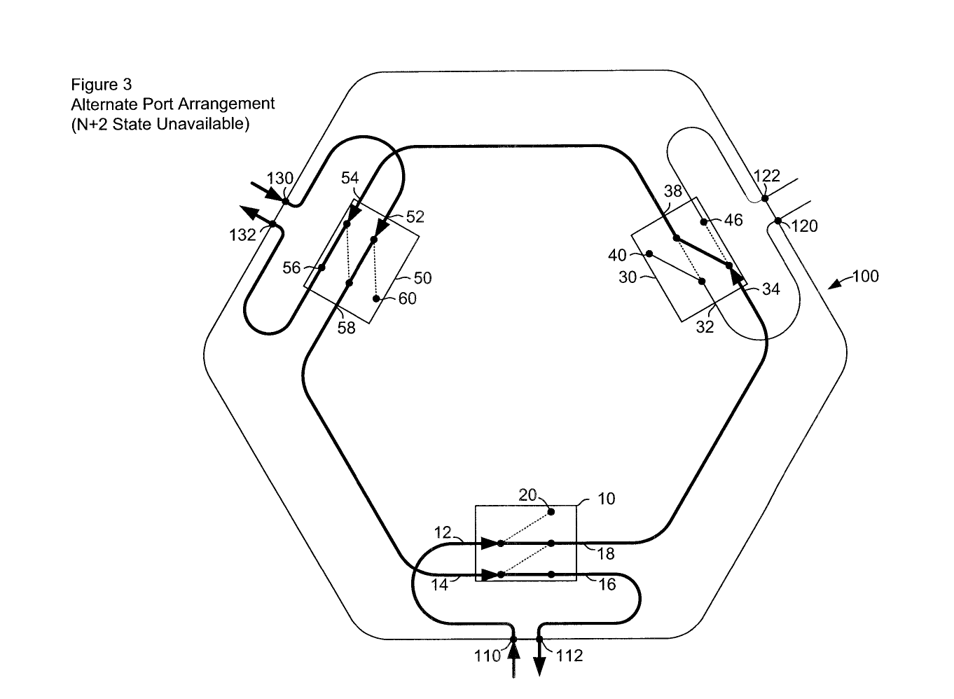

In addition to the possibility of “mirroring” the 3-way roundabouts described above in order to reverse the direction signals travel around the roundabout, it is also possible to configure the 3-way roundabout, as illustrated in FIG. 3, such that each switch element has its own external connection, as opposed to the configuration in FIGS. 1 and 2 where each external connection shares two switches. Accordingly, the exemplary 3-way roundabout of FIG. 3, which illustrates this possibility using parallel-bar switches, adds signals from external connection 120 through switch 30, and drops signals from switch 30 to external connection 122. The arrangement shown in FIG. 3 is capable of 3 bidirectional roundabout states, one of which is illustrated in FIG. 3, and one unidirectional (N+1) state when all switches are in the “=” configuration. The case where all switches are in the “/” configuration is a state where each input signal is sent to the “dump” output of each switch, and although potentially useful for other purposes, (for example, fault isolation) it is not of general importance in the construction of optical roundabout switches.

In placing the overall optical roundabout within the context of a larger system external to the components illustrated in FIG. 3, ports 110 and 112 can be conveniently described as forming a first external connection of the optical roundabout of FIG. 3. Accordingly external connection 110 can also be thought of as the first external connection's add port, and external connection 112 can also be thought of as the first external connection's drop port. This first external connection can, for example, be connected in a bidirectional fashion to additional optical equipment located some distance away from the optical roundabout in a first direction. Similar labels can be applied to ports 120 and 122, which can be conveniently described together as a second external connection, and individually as the second external connection's add external connection 120 and drop external connection 122. By the same token, ports 130 and 132 can be conveniently described as a third external connection, and individually as the third external connection's add external connection 130 and drop external connection 132. The second external connection might, for example, communicate with a piece of optical equipment in a second direction, and the third external connection might, for example, communicate with some other piece of optical equipment in a third direction.

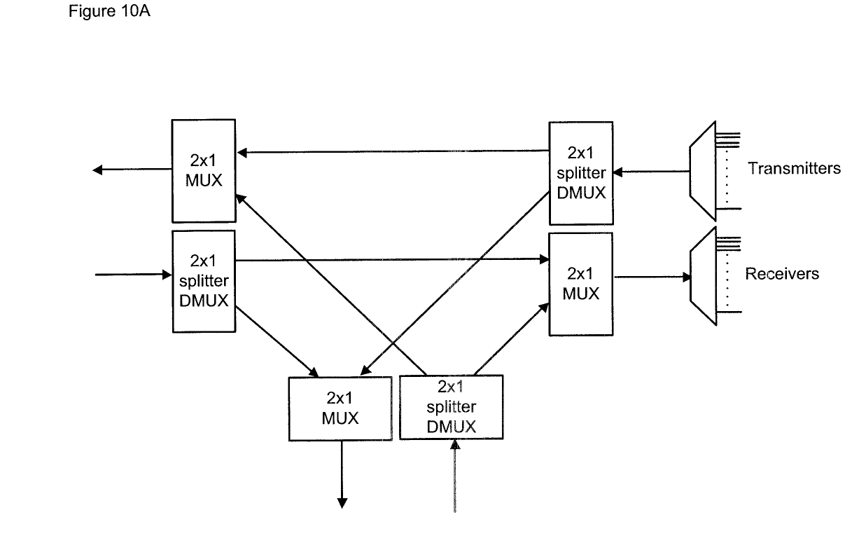

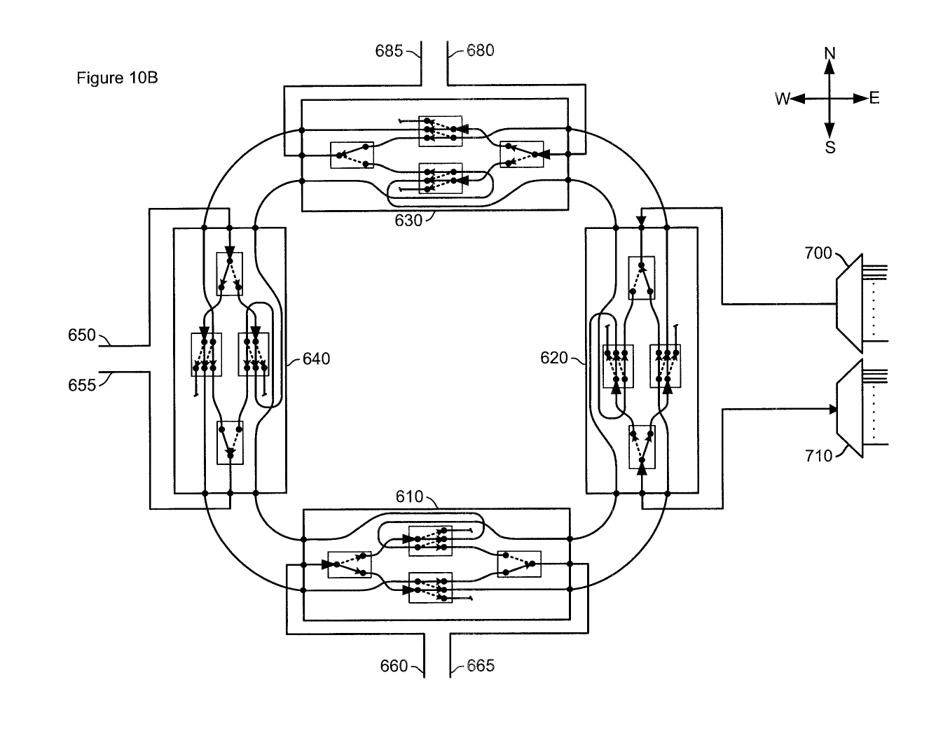

It should be appreciated that the 3-way roundabout of FIGS. 1A through 4 can be easily converted to a DIOADM in a manner analogous to the one shown in FIG. 10A, by simply substituting a 3-way optical roundabout switch for the 3-way broadcast and select switch of the prior art. This could be accomplished by attaching a demultiplexer to the drop port of one of the optical roundabout's external connections, It should also be appreciated that numerous other configurations of the 3-way switch may be achieved by varying the pattern of connections for each switch.

Since each switch in the 3-way roundabout has two inputs and two outputs, because the possible connections on the input side include add and roundabout in ports, and the possible connections on the output side include drop and roundabout out ports, there are at least four possible ways of arranging an optical roundabout switch using only parallel-bar type switches. Similarly, multiple combinations of cross-bar switch are possible, and hybrid optical roundabouts can be constructed which contain both cross-bar and parallel-bar switch elements. It should also be appreciated that any of, or all of, the switch elements in the 3-way optical roundabout switches described herein can be wavelength selective switch elements, leading to significant numbers of possible switch states on a per-wavelength basis.

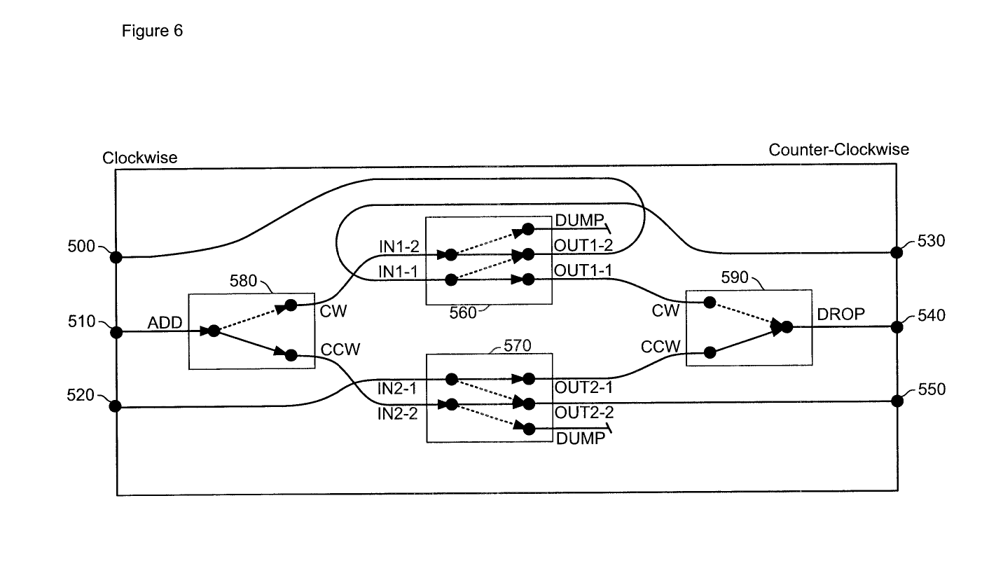

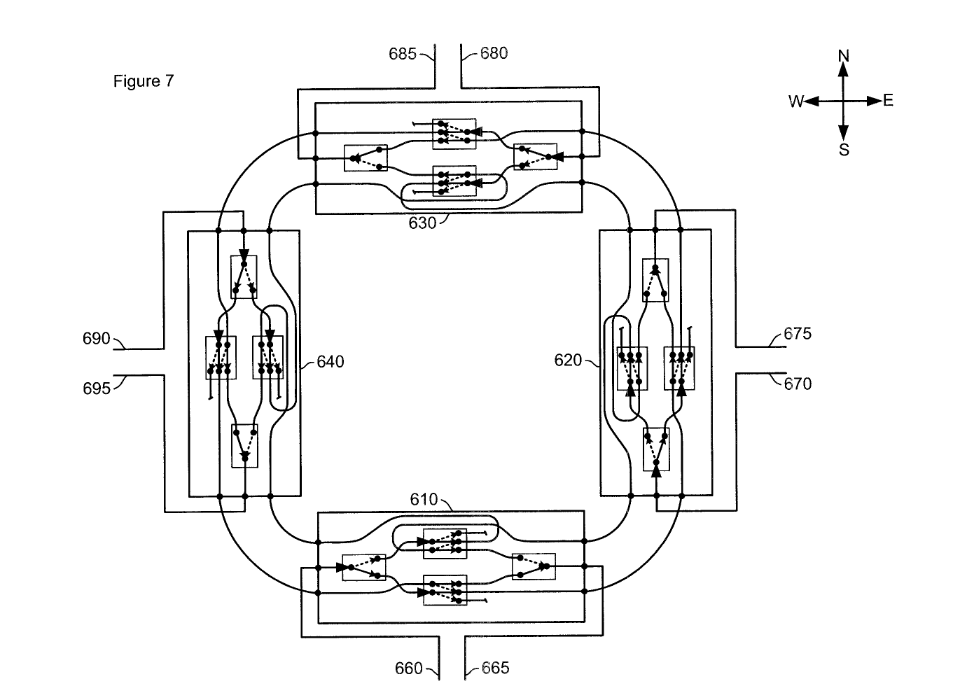

An exemplary embodiment of a 4-way optical roundabout switch is illustrated conceptually in FIGS. 7-9. The construction of the exemplary 4-way optical roundabout switch illustrated in FIGS. 7-9 involves the use of four optical switch modules, one of which is illustrated conceptually in FIG. 6.

The exemplary optical switch module illustrated conceptually in FIG. 6 comprises a first optical switching element 560, a second optical switching element 570, a selective dropping means 590, a selective adding means 580, as well as ports 500, 510, 520, 530, 540 and 550. Ports 500, 510 and 520 correspond to clockwise traffic, in the sense that traffic passing through these ports is either destined to the next optical switch module, going clockwise around the optical roundabout switch, or coming from that next clockwise optical switch; in other words, the clockwise designation is not intended to indicate that all traffic from these ports 500, 510 and 520 is traveling in a clockwise direction, but rather that the traffic through those ports is associated with the next optical switch module along the optical roundabout, going clockwise around the optical roundabout switch. Similarly, ports 530, 540 and 550 are designated counter-clockwise ports, as they are associated with the optical switch module that is the next optical switch module along the optical roundabout, going counterclockwise around the optical roundabout. Port 500 is connected to the second output of the first optical switching element. Port 510 is connected to the input of the selective adding means 580. Port 520 is connected to the first input of the second optical switching element. Port 530 is connected to the first input of the first optical switching element. Port 540 is connected to the output of the selective dropping means 590. Port 550 is connected to the second output of the second optical switching element.

Selective dropping means 590 has at least two inputs CW and CCW, the CCW input being used for dropping an incoming signal coming from the counter-clockwise direction around the roundabout, and the CW input being used for dropping an incoming signal coming from the clockwise direction around the roundabout. The CW input of the selective dropping means 590 is connected to the first output of the first optical switching element 560, and the CCW input of the selective dropping means 590 is connected to the first output of the second optical switching element 570. Selective adding means 580 has at least two outputs CW and CCW, the CW output being used for adding a signal for output from the optical switch module going clockwise around the roundabout, and the CCW output being used for adding a signal for output from the optical switch module going counterclockwise around the roundabout. The CW output of the selective adding means 580 is connected to the second input of the first optical switching element 560, and the CCW output of the selective adding means 580 is connected to the second input of the second optical switching element 570. Selective dropping means 590 and selective adding means 580 can be implemented using any known means of achieving 2:1 and 1:2 optical selectivity, respectively. First and second optical switching elements 560 and 570 may be implemented using parallel-bar type switches of any type, including without limitation the types described above with respect to the parallel-bar 3-way optical roundabout switch. The skilled reader will appreciate that first and second optical switching elements 560 and 570 may be implemented using cross-bar type switches of any type, including without limitation the types described above with respect to the cross-bar 3-way optical roundabout switch, with such modifications to the linkage of the two input ports as may be necessary in order to achieve the routing states functionally equivalent to those described below with reference to FIGS. 7-9. It should also be appreciated that any, or all of the switch elements of FIG. 6 may be wavelength selective switch elements, thus permitting a large number of possible states for the overall switching module on a per-wavelength basis.

FIGS. 7-9 are conceptual illustrations of a 4-way optical roundabout switch constructed using four optical switch modules of the type illustrated in FIG. 6, and of two potential operating states of that optical roundabout switch. The overall 4-way optical roundabout switch comprises a first optical switch module 610 having an add input 660 and a drop output 665, a second optical switch module 620 having an add input 670 and a drop output 675, a third optical switch module 630 having an add input 680 and a drop output 685, and a fourth optical switch module 640 having an add input 690 and a drop output 695. For convenience, add/drop signals traveling through add input 660 and drop output 665 can be referred to as ‘south’, add/drop signals traveling through add input 670 and drop output 675 can be referred to as ‘east’, add/drop signals traveling through add input 680 and drop output 685 can be referred to as ‘north’, and add/drop signals traveling through add input 690 and drop output 695 can be referred to as ‘west’.

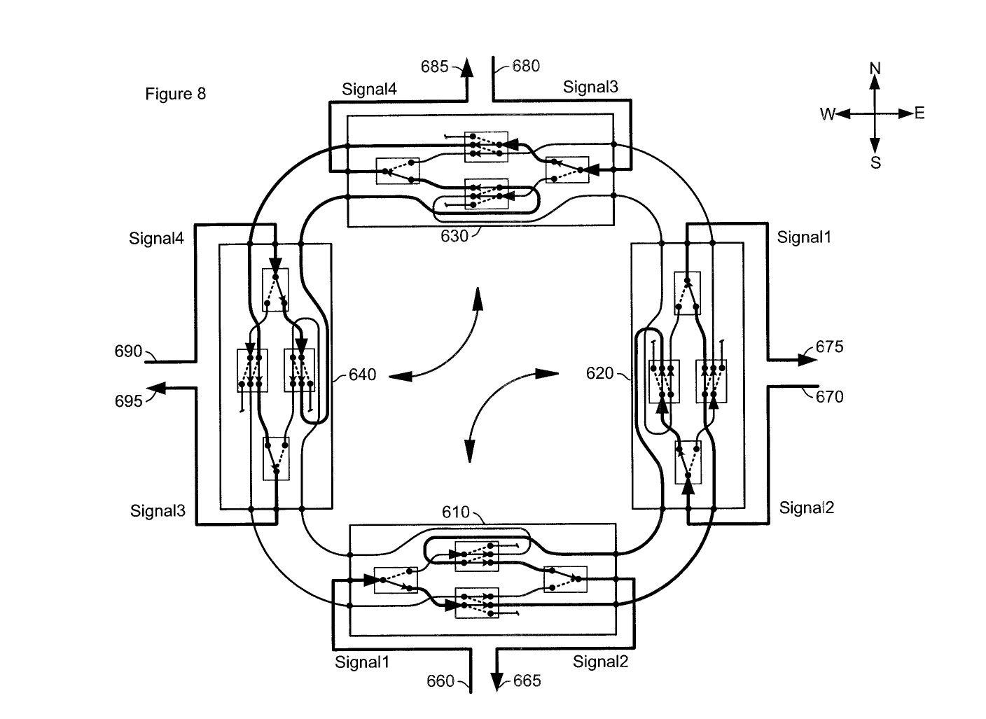

The second output of each Nth optical switch module's first optical switching element is optically connected to the first input of the first optical switching element of the (N+1)th optical switch module, where 1≦N≦3. In the case where N=4, the second output of the first optical switching element of the fourth optical switch module is optically connected to the first input of the first optical switching element of the first optical switch module. Likewise, the second output of the second optical switching element of the Nth optical switch module is optically connected to the first input of the second optical switching element of the (N+1)th optical switch module, where. These optical connections can be any known form of optical waveguide, where 1≦N≦3. In the case where N=4, the second output of the second optical switching element of the fourth optical switch module is optically connected to first input of the second optical switching element of the first optical switch module. Accordingly, two paths around the 4-way optical roundabout switch are formed, a clockwise path, and an anticlockwise path. Of course, the configuration of the 4-way roundabout switch illustrated in FIG. 8 is subject to the same mirror-symmetry reproduction as the 3-way roundabout illustrated in FIGS. 1A-1B.

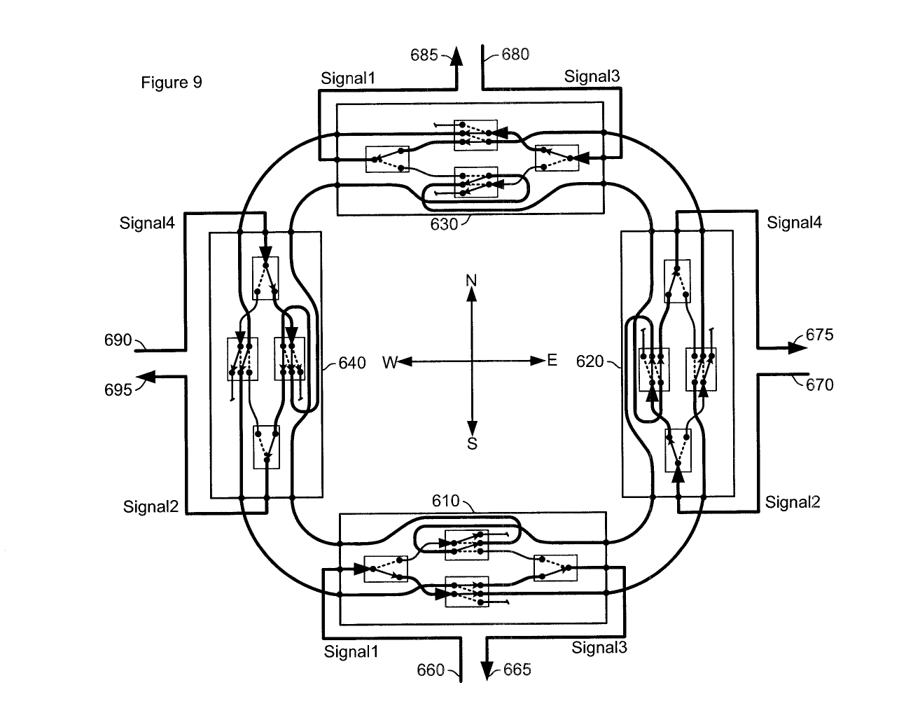

As can be seen from FIGS. 8 and 9, the 4-way optical roundabout switch can assume two types of state. FIG. 8 illustrates the case where the 4-way optical roundabout switch can form connections from north to west, west to north, east to south, and south to east. It will be appreciated by the skilled reader that the configuration of FIG. 8 has several rotationally symmetric analogues, each of which may also operate in a configuration that exhibits mirror symmetry. FIG. 9 illustrates the case where the 4-way optical roundabout switch can form connections from north to south, east to west, south to north and west to east. The primary means of accomplishing these configurations is by altering the position of the selective adding means and selective dropping means for any given optical switch module, and/or altering the position of the first and/or second optical switching element of any given optical switch module. It will be appreciated by the skilled reader that, due to the larger number of switch elements making up each node of a 4-way optical roundabout switch, the number of possible states for the overall 4-way optical roundabout switch is greater than the number of possible states for 3-way optical roundabout switches.

The exemplary north to west, west to north, east to south, and south to east configuration illustrated conceptually by FIG. 8 will now be described in order to better illustrate the operation of a 4-way optical roundabout switch constructed according to one embodiment of the present invention. Four signals are being transmitted in the exemplary switch configuration illustrated in FIG. 8: signal 1 is being transmitted from south to east, signal 2 is being transmitted from east to south; signal 3 is being transmitted from north to west, and signal 4 is being transmitted from west to east. The paths taken by signals 1 and 3 are rotationally symmetric to each other. The paths taken by signals 2 and 4 are rotationally symmetric to each other. Regarding signal 1, it enters the first optical switch module 610 through add port 660. Referring to the components within the first optical switch module 610 according to the description set out above with respect to FIG. 6, signal 1 enters selective adding means 580 of the first optical switch module 610, which directs signal 1 through its CCW output to the second input IN2-2 of the second optical switch element 570 of the first optical switch module 610. The second optical switch element 570 of the first optical switch module 610 has inputs that are tied in a “=” configuration such that the IN2-2 input is routed to the OUT2-2. Signal 1 proceeds from the OUT2-2 output of the second optical switch element 570 of the first optical switch module 610 to the first input IN2-1 of the second optical following optical switch element 570 of the second optical switch module 620. The second optical switch element 570 of the second optical switch module 620 has inputs that are tied in a “=” configuration such that the IN2-1 input is routed to the OUT2-1 output. Signal 1 proceeds to CCW input of the selective dropping means 590 of the second optical switch module 620, which is configured to drop signal 1 through drop port 675.

Turning now to signal 2 in the exemplary switch configuration of FIG. 8, it can be seen that its travel from east to south is along a clockwise series of connections around the 4-way optical roundabout switch, and proceeds according to the following sequence: from add port 670 to selective adding means 580 of the second optical switch module 620, which directs the signal to its CW output; from the CW output of the selective adding means 580 of the second optical switch module 620 to the second input IN1-2 of the first optical switch element 560 of the second optical switch module 620, which routes signal 2 from IN1-2 to the second output OUT1-2 of the first optical switch element 560 of the second optical switch module 620; from the second output OUT1-2 of the first optical switch element 560 of the second optical switch module 620 to the first input IN-1 of the first optical switch element 560 of the first optical switch module 610, which routes signal 2 from IN1-1 to the first output OUT1-1 of the first optical switch element 560 of the first optical switch module 610; from the first output OUT1-1 of the first optical switch element 560 of the first optical switch module 610 to the CW input of selective dropping means 590 of the first optical switch module 610, which drops signal 2 through drop port 665.

Having regard to the foregoing description and the exemplary optical roundabout illustrated in FIGS. 6-9, it can be seen that the absence of splitters in the 4-way optical roundabout means that losses are correspondingly lower than in a 4-way broadcast and select junction, which reduces the signal strength of each incoming signal by at least a factor of three.

It will be appreciated by the skilled reader that DIOADMs with branching capability may be constructed using the 4-way optical roundabout switch of FIGS. 7-9, as illustrated conceptually in FIG. 10B, by simply substituting a 4-way optical roundabout switch for the broadcast and select architecture shown in FIG. 10A. Similarly, a bidirectional OADM may be constructed by adding a second multiplexer/demultiplexer pair to the opposite side of the 4-way optical roundabout switch to the first pair. For example, the DIOADM of FIG. 10B could be converted by adding a second multiplexer/demultiplexer pair to the west side of the 4-way optical roundabout switch, to complement the pair 700, 710 on the east side.

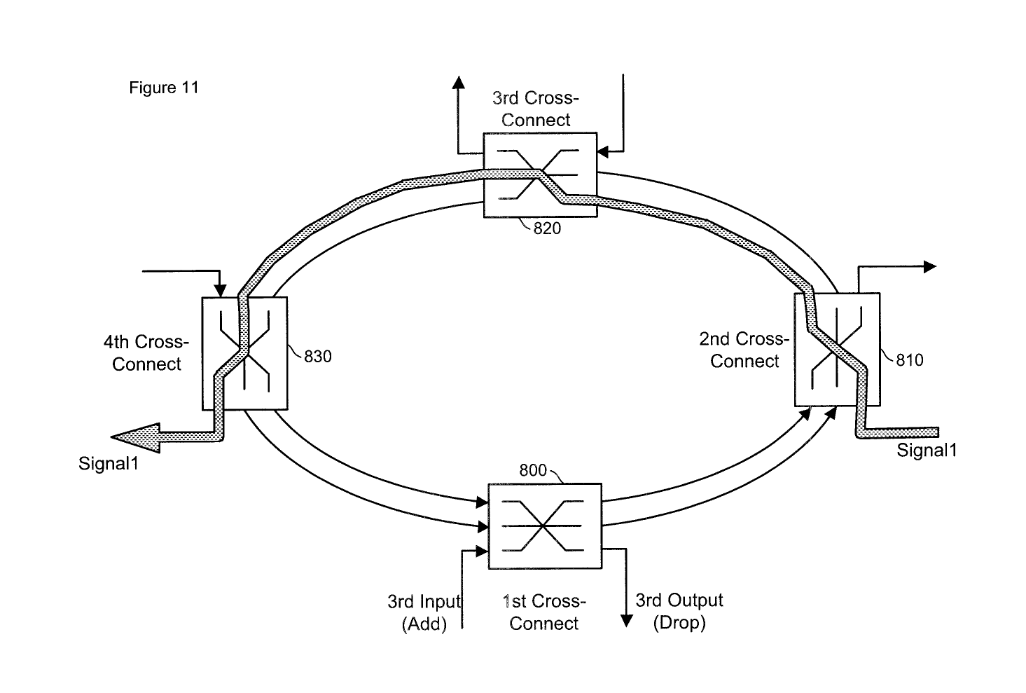

FIG. 11 illustrates the general case of an M-way optical roundabout switch. Although an exemplary 4-way optical roundabout switch is shown, the roundabout switch of FIG. 11 may be generalized as follows: in an M-way optical roundabout switch, there are M optical cross-connects each having (M−1)×(M−1) cross-connectivity. Each of the M optical cross-connects in an M-way optical roundabout switch is connected to its neighbours around the optical roundabout by (M−2) optical waveguides. Each of the M optical cross-connects has an add port and a drop port.

The operation of the exemplary 4-way optical roundabout of FIG. 11 can be illustrated by considering the transmission of a hypothetical signal from a 2nd cross-connect 810 through a 3rd cross-connection 820 to a 4th cross-connect 830. Signal 1 enters the 2nd cross-connect 810 through its add port, and is transmitted counterclockwise along the innermost optical waveguide ring of the optical roundabout to one of the inputs to the 3rd optical cross-connect 820. The 3^{rd} optical cross-connect 820 transmits signal 1 along the outermost optical waveguide ring of the optical roundabout to one of the inputs of the 4th optical cross-connect 830. Finally, the 4th optical cross-connect 830 drops signal 1 via its drop port.

It should be appreciated that the use of (M−1)×(M−1) optical cross connects rather than parallel-bar or cross-bar type switches provides a greater degree of flexibility in allowing signals to travel around the optical roundabout. Accordingly, the number of states that may be assumed by the 4-way optical roundabout illustrated in FIG. 11 is larger than the number of states that may be assumed by the 4-way optical roundabout of FIGS. 7-9.

M-way optical roundabout switches having large values of M can be constructed in this manner. For example, a 5-way optical roundabout switch would require 5 optical-cross connects having 4×4 connectivity, each of which would be connected to its nearest clockwise and anticlockwise neighbours by 3 optical waveguides. It should be appreciated that, by employing wavelength selective optical cross-connects, a large number of possible states for the M-way optical roundabout can be achieved on a per-wavelength basis.

In the above description, for purposes of explanation, numerous details have been set forth in order to provide a thorough understanding of the present invention. However, it will be apparent to one skilled in the art that these specific details are not required in order to practice the present invention.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. An optical roundabout comprising:
three internal optical switching elements arranged in a ring, each internal optical switching element having two input ports routable to two output ports, the routing of the first input of each internal optical switch being ganged to the routing of the second input for that switch;
each internal optical switching element's two input ports including an add port and a roundabout-in port; and
each internal optical switching element's two output ports including a drop port and a roundabout-out port;
wherein the roundabout-out port of each optical switching element is connected to the roundabout-in port of its next optical switching element around the ring by an optical waveguide.

2. The optical roundabout of claim 1 further comprising three external connections arranged in a ring, each external connection having a drop output port in optical communication with the drop output port of a corresponding internal optical switching element and an add input port in optical communication with the add input port of the next optical switching element around the ring from said corresponding internal optical switching element, each internal optical switching element having a single-hop unidirectional switching state for routing optical signals from the add port of each external connection to the drop port of its next external connection around the ring.

3. The optical roundabout of claim 1 further comprising three external connections arranged in a ring, each external connection having a drop output port in optical communication with the drop output port of a corresponding internal optical switching element and an add input port in optical communication with the add input port of the next optical switching element around the ring from said corresponding internal optical switching element, each internal optical switching element having a double-hop unidirectional switching state for routing optical signals from its add port to the drop port of the previous internal optical switching element around the ring.

4. The optical roundabout of claim 1 further comprising three external connections, each external connection having a drop output port in optical communication with the drop output port of a corresponding internal optical switching element and an add input port in optical communication with the add input port of the next optical switching element around the ring from said corresponding internal optical switching element, the optical roundabout having at least one bidirectional switching state for routing optical signals between two external connections wherein two of the internal optical switching elements are in a first switching state and one of the internal optical switching elements is in a second switching state.

5. The optical roundabout of claim 1 further comprising three external connections arranged in a ring, each external connection having a drop output port in optical communication with the drop output port of a corresponding internal optical switching element and an add input port in optical communication with the add input port of said corresponding internal optical switching element, each internal optical switching element having a single-hop unidirectional switching state for routing optical signals from the add port of each external connection to the drop port of its next external connection around the ring.

6. The optical roundabout of claim 1 further comprising three external connections arranged in a ring, each external connection having a drop output port in optical communication with the drop output port of a corresponding internal optical switching element and an add input port in optical communication with the add input port of said corresponding internal optical switching element, the optical roundabout having at least one bidirectional switching state for routing optical signals between two external connections wherein two of the internal optical switching elements are in a first switching state and one of the internal optical switching elements is in a second switching state.

7. The optical roundabout switch of claim 1 further comprising a variable optical attenuator connected to a port of one of the internal optical switching elements.

8. The optical roundabout switch of claim 1 further comprising a multiplexer having an output port in optical communication with an add port of one of the three internal optical switching elements.

9. The optical roundabout switch of claim 1 further comprising a demultiplexer having an input port in optical communication with the drop port of one of the three internal optical switching elements.

10. The optical roundabout switch of claim 1 wherein the second input of the first switch is connected to the output of a multiplexer, and the second output of the first switch is connected to the input of a demultiplexer.

11. An optical roundabout switch comprising:
M optical (M−1)×(M−1) optical cross-connects, where M is at least three, each optical cross-connect having an (M−1)th input for adding an optical signal, and an (M−1)th output for dropping an optical signal;
M−2 optical waveguides connecting the first M−2 outputs of the Nth optical cross-connect to the first M−2 inputs of the (N+1)th optical cross connect, for 1≦N≦M−1; and
M−2 optical waveguides connecting the first M−2 outputs of the Mth optical cross-connect to the first M−2 inputs of the first optical cross connect.

12. An optical roundabout switch comprising:
four optical switch modules arranged in a ring, each optical switch module comprising:
a first internal optical switching element and a second optical switching element, each of said first and second optical switching elements having:
first and second inputs, and
first and second outputs,
a selective dropping means for selectably dropping an optical signal from the first output of either of the first optical switch or the second optical switch, and
a selective adding means for selectably adding an optical signal to the second input of either the first optical switch or the second optical switch; and
wherein the routing of the first input within each of the optical switching elements is ganged to the routing of the second input for that optical switching element;
an optical waveguide connecting the second output of the first optical switching element of each optical switch module to the first input of the first optical switching element of a next optical switch module around the ring; and
an optical waveguide connecting the second output of the second optical switching element of each optical switch module to the first input of the second optical switching element of the next optical switch module around the ring.

13. The optical roundabout switch of claim 12 wherein the selective adding means of the first optical switching module is connected to the output of a multiplexer, and the selective dropping means of the first optical switching module is connected to the input of a demultiplexer.

14. The optical roundabout switch of claim 12 wherein the selective adding means of the first optical switching module is connected to the output of a multiplexer, the selective dropping means of the first optical switching module is connected to the input of a demultiplexer, the selective adding means of the third optical switching module is connected to the output of a multiplexer, and the selective dropping means of the third optical switching module is connected to the input of a demultiplexer.

15. The optical roundabout switch of claim 11 further comprising a variable optical attenuator connected to a port of one of the internal optical switching elements.
